(19) United States
(12) Patent Application Publication
(10) Pub. No.: US 2007/0245372 A1
(43) Pub. Date: Oct. 18, 2007

(54) Management device, method and program for monitoring video data transmitted via network

(75) Inventor: Masaru Yasuda, Nagoya (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/700,133

(22) Filed: Jan. 31, 2007

(30) Foreign Application Priority Data
Jan. 31, 2006 (JP) 2006-023708

(51) Int. Cl. H04N 5/445; H04N 7/025; H04N 7/16

(52) U.S. Cl. 725/34; 725/45; 725/9

(57) ABSTRACT

There is provided a management device comprising a network device recognition unit configured to identify at least one predetermined device in a network by judging whether the at least one predetermined device satisfies a predetermined condition, a monitoring target setting unit which sets the at least one predetermined device as a monitoring target, a judgment unit which judges whether video data is being transmitted via the network to the at least one predetermined device, a packet acquisition unit which acquires packets of the video data being transmitted to the at least one predetermined device if the judgment unit judges that the video data is being transmitted to the at least one predetermined device, a monitoring image data generating unit which generates monitoring image data based on the packets of the video data, and an output control unit which makes an output unit output the monitoring image data.

### CROSS-REFERENCE TO RELATED APPLICATION

This application claims priority under 35 U.S.C. §119 from Japanese Patent Application No. 2006-023708, filed on Jan. 31, 2006. The entire subject matter of the application is incorporated herein by reference.

### BACKGROUND

1. Technical Field

Aspects of the present invention relate to a management device and a program for monitoring video data that are transmitted via a network.

2. Related Art

In recent years, vast amounts of video data are communicated via networks such as the Internet to be used in various ways. For example, there exist systems distributing video data from a server accumulating a variety of video data to each terminal device on the client side to let a user of the system view video that is displayed on the terminal device according to the distributed video data. Real-time video and voice communication among multiple participants in remote places by use of a network such as the Internet (e.g. teleconferencing system) has also become widespread today.

There also exist techniques for monitoring video data transmitted via a network and selectively recording video data satisfying prescribed conditions. In a technique disclosed in Japanese Patent Provisional Publication No. 2005-229601 (hereinafter referred to as a “JP 2005-229601A”), data communicated on a network are filtered for conference video data based on their header information, and only the conference video data are recorded selectively.

However, the sniffer technique of JP 2005-229601A, monitoring all the data transmitted on the network to first identify the type of each piece of data (irrespective of whether the data is video data or not) and then acquiring necessary video data from the monitored data by the filtering, is required to monitor not only video data but also data irrelevant to video data (e.g. still image data). Handling such irrelevant data also as monitoring targets is undesirable since the need of constantly checking whether a delay, lack, etc. of a packet have occurred during the packet communication due to the traffic load on the network or not in regard to packets made up of a plurality of frames (such as video data) makes the traffic load still heavier. Further, the monitoring of all the data transmitted on the network results in a considerably heavy processing load on the monitoring side.

### SUMMARY

Aspects of the present invention are advantageous in that a management device, capable of exclusively monitoring video data with high efficiency in a system in which various types of data including video data are transmitted via a network, can be provided.

### BRIEF DESCRIPTION OF THE ACCOMPANYING DRAWINGS

FIG. 1 is a block diagram showing an example of the overall composition of a video data delivery system including a management device in accordance with a first embodiment of the present invention.

FIG. 2 is a block diagram showing an example of the composition of a printing device as the management device.

FIG. 3 is a block diagram showing an example of the electrical configuration of each server included in the video data delivery system.

FIG. 4 is a flow chart showing a video data monitoring process which is executed by the printing device.

FIG. 5 is a schematic diagram for explaining the storing of still image data.

FIG. 6 is a table showing an example of a monitoring output screen.

FIG. 7 is a schematic diagram for explaining designation of a printout.

FIG. 8 is a schematic diagram showing an example of the printout.

FIG. 9 is a schematic diagram showing another example of the printout.

FIG. 10 is a schematic diagram showing still another example of the printout.

FIG. 11 is a flow chart showing a video data monitoring process which is executed by a printing device as a management device in accordance with a second embodiment of the present invention.

FIG. 12 is a table showing an example of a monitoring output screen displayed by the printing device in the second embodiment.

FIG. 13 is a block diagram showing a video data delivery system including a management device (implemented by a first-class network device) in accordance with a third embodiment of the present invention.

FIG. 14 is a block diagram showing an example of the composition of the first-class network device configured as the management device in the third embodiment.

### DETAILED DESCRIPTION

General Overview

It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

According to an aspect of the invention, there is provided a management device for monitoring video data transmitted via a network. The management device comprises a network device recognition unit configured to identify at least one predetermined device in the network by judging whether the at least one predetermined device satisfies a predetermined condition; a monitoring target setting unit which sets the at least one predetermined device identified by the network device recognition unit as a monitoring target; a judgment unit which judges whether or not video data is being transmitted via the network to the at least one predetermined device set by the monitoring target setting unit as the monitoring target; a packet acquisition unit which acquires packets of the video data being transmitted to the at least one predetermined device on the network if the judgment unit judges that the video data is being transmitted to the at least one predetermined device; a monitoring image data generating unit which generates monitoring image data based on the packets of the video data acquired by the packet acquisition unit; and an output control unit which makes an output unit output the monitoring image data generated by the monitoring image data generating unit.

The management device configured as above is capable of exclusively monitoring video data with high efficiency in a system in which various types of data including video data are transmitted via a network.

In at least one aspect, the predetermined condition used by the network device recognition unit is a condition on whether the predetermined device is able to reproduce video data.

In at least one aspect, the network device recognition unit recognizes and discriminates between first-class network devices receiving video data via the network and having a video reproducing function of reproducing video according to the received video data and second-class network devices not having the video reproducing function on the network on which the first-class network devices and the second-class network devices coexist so that the first-class network devices are identified as the at least one predetermined device. The monitoring target setting unit sets the first-class network devices recognized by the network device recognition unit as monitoring targets. The judgment unit judges whether or not video data is being transmitted via the network to each of the first-class network devices set by the monitoring target setting unit as the monitoring targets. The packet acquisition unit which acquires packets of the video data being transmitted to each first-class network device on the network if the judgment unit judges that the video data is being transmitted to the first-class network device.

With the above configuration, the management device is capable of recognizing the first-class network devices (capable of playing back video data, that is reproducing video from video data) connected to the network by use of the network device recognition unit and setting the recognized first-class network devices as the monitoring targets by use of the monitoring target setting unit. When the judgment unit judges that video data is being transmitted to a first-class network device as a monitoring target, the packet acquisition unit acquires packets of the video data, the monitoring image data generating unit generates monitoring image data based on the packets of the video data, and the output control unit makes the output unit output (display, print out, etc.) the monitoring image data as monitoring images. Since it is unlikely that video data is transmitted to a device incapable of playing back video data, the need of monitoring irrelevant data (data that are not video data) transmitted on the network can be eliminated by previously detecting first-class network devices (capable of reproducing video from video data) and setting the detected first-class network devices as the monitoring targets. Therefore, the management device configured as above is capable of exclusively monitoring video data with high efficiency in a system in which various types of data including video data are transmitted via a network.

In at least one aspect, the monitoring image data generating unit generates monitoring video data, having a reduced number of image frames per unit time compared to the video data transmitted to the at least one predetermined device, as the monitoring image data based on the packets of the video data acquired by the packet acquisition unit, and the output control unit makes the output unit output video according to the monitoring video data as the monitoring images.

With the above configuration, the monitoring images can be outputted after reducing the data amount of the video data acquired as the packets. In other words, the monitoring of video data can be executed efficiently by the reduced output of data (monitoring video data) as part of the monitored video data.

In at least one aspect, the monitoring image data generating unit is a still image data generating unit which generates still image data as the monitoring image data, and the output control unit makes the output unit output one or more still images according to the still image data as the monitoring images.

With the above configuration, the management device generates still image data from the packets of the video data acquired by the packet acquisition unit, and outputs one or more still images according to the still image data as the monitoring images. In other words, the management device is capable of outputting part of the video data transmitted via the network as still images, by which the user can grasp what kind of video data are being transmitted via the network.

In at least one aspect, the packet acquisition unit continues periodical acquisition of the packets of the video data while the video data is transmitted to the at least one predetermined device. The still image data generating unit generates still image data of a plurality of still images along a time series of packet acquisition by the packet acquisition unit based on the packets of the video data acquired by the packet acquisition unit. The output control unit makes the output unit output the still images according to the still image data.

With the above configuration, the management device is capable of generating still image data of a plurality of still images from the video data at prescribed times of day during the packet transmission, for example, and outputting the still images as the monitoring images, by which the user can grasp what kind of video data were transmitted at the prescribed times of day by viewing the outputted still images.

In at least one aspect, the management device further comprises a storage control unit which stores the still image data in a storage unit, and the output control unit makes the output unit output one or more still images according to the still image data stored in the storage unit in response to receipt of an output request from a user.

With the above configuration, the management device can let the user grasp part of the video data as still images, by outputting the still image data stored in the storage unit as the still images in response to the output request from the user.

The output control unit may be configured to make the output unit print out one or more still images according to the still image data.

With the above configuration, the user can grasp part of the video data as the still images printed on a sheet such as paper.

In at least one aspect, the output control unit makes the output unit output identification information, capable of specifying the first-class network device reproducing video according to the video data formed by the packets, together with the monitoring images.

With the above configuration, the user can easily recognize which first-class network device is the destination of the video data.

In at least one aspect, the output control unit makes the output unit output identification information, capable of specifying a server as the source of the packets, together with the monitoring images.

With the above configuration, the user can easily recognize the device (server) as the source of the packets.

In at least one aspect, the output control unit makes the output unit output identification information, capable of specifying the video data formed by the packets, together with the monitoring images.

With the above configuration, the identification/recognition of the video data by the user can be facilitated by outputting the title, playback date/time, etc. of the video data, for example, together with the monitoring images.

The judgment unit may be configured to make the judgment on whether or not video data is being transmitted to the at least one predetermined device by judging whether or not the at least one predetermined device has issued a video data transmission request to a server on the network.

With the above configuration, the management device constantly checks whether each first-class network device issues a video data transmission request to a server or not. When a video data transmission request has been issued by a first-class network device that has been set as a monitoring target, the judgment unit can judge that video data is being transmitted to the first-class network device via the network (or the video data is being played back by the first-class network device).

According to another aspect of the invention, there is provided a computer readable medium having computer readable instructions stored thereon, which, when executed by a computer, are configured to identify at least one predetermined device in the network by judging whether the at least one predetermined device satisfies a predetermined condition; to set the at least one predetermined device as a monitoring target; to judge whether or not video data is being transmitted via the network to the at least one predetermined device set as the monitoring target; to acquire packets of the video data being transmitted to the at least one predetermined device on the network if it is judged that the video data is being transmitted to the at least one predetermined device; to generate monitoring image data based on the acquired packets of the video data; and to make an output unit output the monitoring image data generated as monitoring images.

The instructions configured as above enables the management device to be capable of exclusively monitoring video data with high efficiency in a system in which various types of data including video data are transmitted via a network.

In at least one aspect, the predetermined condition is a condition on whether the at least one predetermined device has a video reproducing function.

According to another aspect of the invention, there is provided a method of monitoring video data transmitted via a network, comprising: identifying at least one predetermined device in the network by judging whether the at least one predetermined device satisfies a predetermined condition; setting the at least one predetermined device as a monitoring target; judging whether or not video data is being transmitted via the network to the at least one predetermined device set as the monitoring target; acquiring packets of the video data being transmitted to the at least one predetermined device on the network if it is judged that the video data is being transmitted to the at least one predetermined device; generating monitoring image data based on the acquired packets of the video data; and making an output unit output the monitoring image data generated as monitoring images.

With the above configuration, effects similar to those of the aforementioned management device can be achieved.

In at least one aspect, the predetermined condition is a condition on whether the at least one predetermined device has a video reproducing function.

### EMBODIMENT

Referring now to the drawings, a description will be given in detail of preferred embodiments in accordance with the present invention.

### First Embodiment

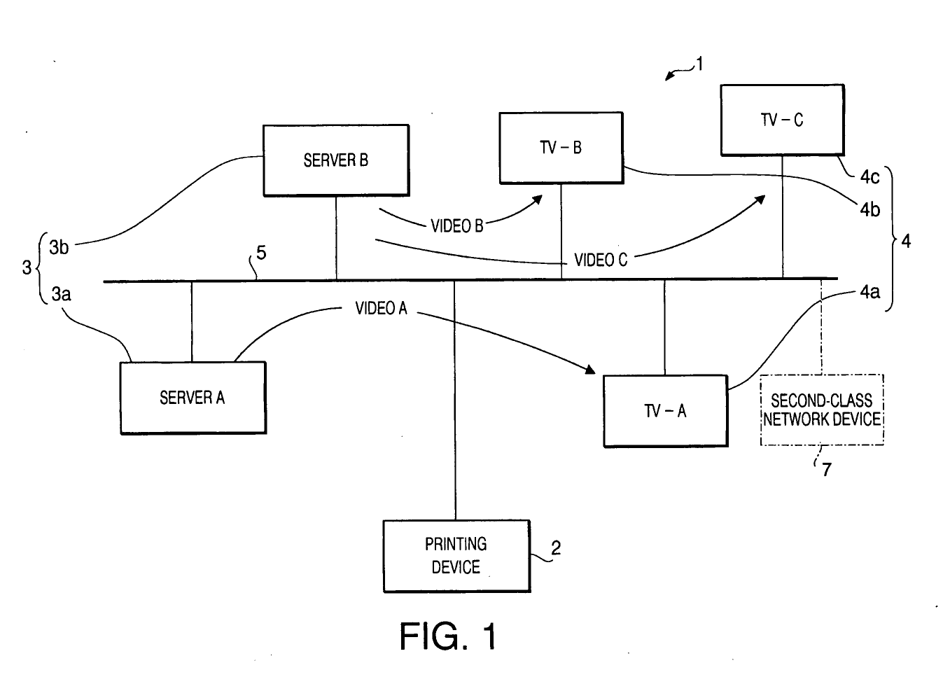

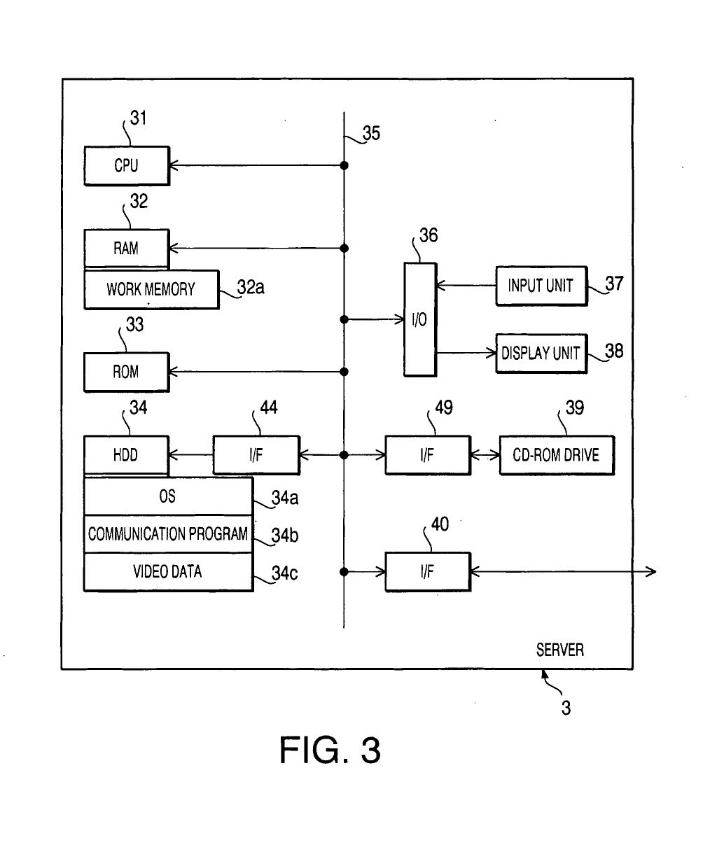

FIG. 1 is a block diagram showing an example of the overall composition of a video data delivery system including a management device in accordance with a first embodiment of the present invention. The video data delivery system 1 shown in FIG. 1 includes servers 3 (server 3a (server A), server 3b (server B)), first-class network devices 4 (TV (television) 4a (TV A), TV 4b (TV B), TV 4c (TV C)) and a printing device 2 which are connected together by a network 5. Each server 3 accumulates and delivers video data 34c (see FIG. 3). Each first-class network device 4 plays back the delivered video data 34c, that is, reproduces video from the delivered video data 34c. The printing device 2, functioning as the management device in the video data delivery system of FIG. 1, monitors the video data 34c and outputs the result of the monitoring. The network 5 can be implemented as a wired communication network employing serial communication cables, parallel communication cables, LAN cables, etc., or as a wireless communication network employing a wireless LAN, IEEE 802.11x, Bluetooth®, etc. Each of the devices (server 3, first-class network device 4, printing device 2) is equipped with a network interface to communicate data via the network 5.

Each of the devices (server 3, first-class network device 4, printing device 2) is configured as a device supporting a network device automatic detecting protocol such as UPnP (Universal Plug and Play). The UPnP is a set of technical specifications for interconnecting various devices (PCs (Personal Computers), peripheral devices, AV (Audio and Visual) equipment, telephone sets, home electric appliances, etc.) by a network 5 and letting the devices share their functions. The UPnP, designed based on standard technologies used on the Internet, allows the user to use each device (allows each device to function normally) only by connecting the device to the network 5, without the need of complicated operations and troublesome setting tasks.

Each first-class network device 4 is configured as a network television having a network connection function and a video reproducing function, to be capable of requesting a server 3 to transmit video data 34c, receiving packets of the video data 34c transmitted from the server 3, and reproducing and displaying video from the received video data 34c. In short, the user is allowed to view desired content (formed by the encoded video data 34c) supplied via the network 5.

Further, network home appliances such as air conditioners and light fixtures may also be connected to the network 5 as second-class network devices 7.

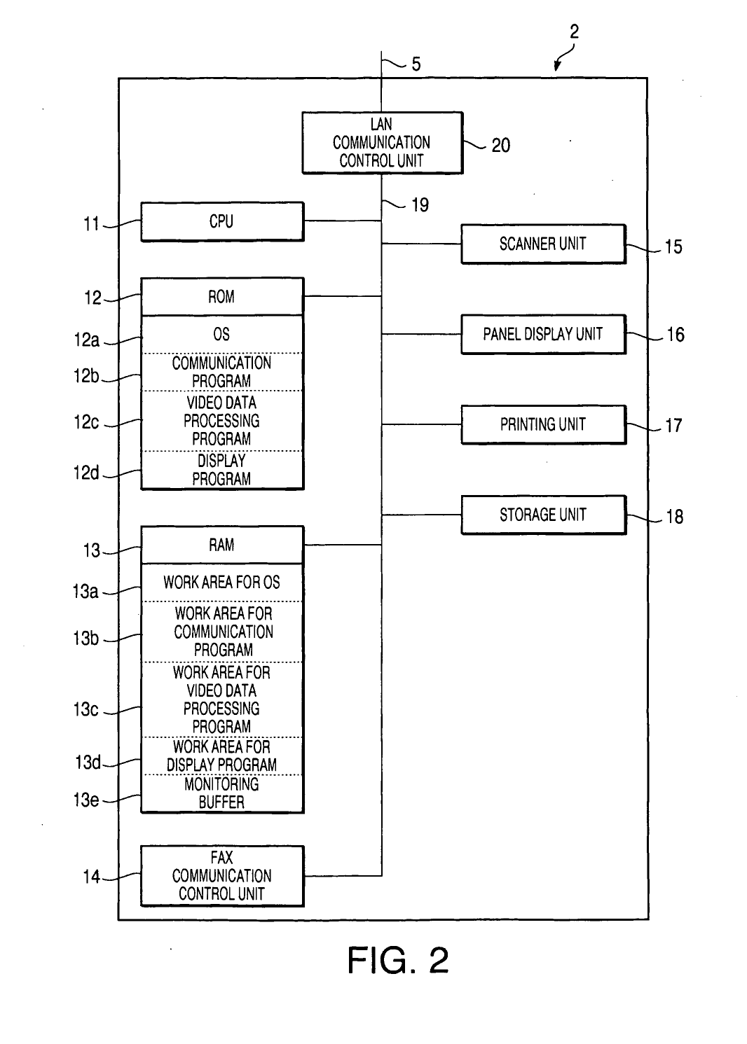

FIG. 2 is a block diagram showing an example of the composition of the printing device 2 as the management device in the video data delivery system. The printing device 2 includes a CPU (Central Processing Unit) 11, a ROM (Read Only Memory) 12 storing various programs, a RAM (Random Access Memory) 13 having work memory, a FAX communication control unit 14, a scanner unit 15, a panel display unit 16, a printing unit 17, a storage unit 18, a bus line 19, and a LAN communication control unit 20 connected to the network 5. The printing device 2, configured as an MFP (Multi-Function Peripheral), printer, etc. capable of forming an image on an image formation medium (e.g. paper) according to print data transmitted from a server 3, etc., has the function of the management device.

The CPU 11, as a central computation device for controlling the whole of the printing device 2, is connected to the ROM 12 (explained later), the RAM 13 (explained later), etc. via the bus line 19. The CPU 11 reads out and executes the various programs stored in the ROM 12.

The ROM 12, as a read-only storage device, stores an OS (Operating System) 12a, a communication program 12b, a video data processing program 12c, a printing program 12d for executing a printing process, etc. Meanwhile, in the RAM 13, work areas 13a, 13b, 13c and 13d (for the programs 12a, 12b, 12c and 12d, respectively) and a monitoring buffer 13e (to be used for the monitoring of video data) are formed.

The FAX communication control unit 14 controls the transmission and reception of FAX data. The scanner unit 15 includes an image sensor, etc. and thereby executes document scanning for copying or FAX transmission. The panel display unit 16 includes a display unit (implemented by an LCD, etc.), an input unit (made up of a touch panel, push button switches, numeric keys, etc.), etc. The printing unit 17, including a well-known printing mechanism such as an inkjet printing mechanism, laser printing mechanism, thermal transfer printing mechanism or dot impact printing mechanism, prints an image, etc. on an image formation medium (e.g. paper).

The storage unit 18, as a readable and writable storage device configured as an HDD (Hard Disk Drive), for example, stores data received from the network 5. The storage unit 18 may also be implemented by a nonvolatile memory like an EEPROM (Electrically Erasable & Programmable Read Only Memory).

The video data 34c transmitted from the servers 3a and 3b and a list of the first-class network devices 4a, 4b and 4c (which have been found by a search and set as monitoring targets by the printing device 2) are stored in the monitoring buffer 13e or the storage unit 18. In the list, intrinsic information on each of the first-class network devices 4a, 4b and 4c, such as a MAC (Media Access Control) address, an IP (Internet Protocol) address and a device name, is stored. Incidentally, the storage unit 18 can be left out when a sufficient memory area (storage capacity) can be secured in the RAM 13.

The LAN communication control unit 20 is configured as a well-known LAN card, via which the printing device 2 is connected to the network 5.

The CPU 11 executes the programs 12a, 12b, 12c and 12d stored in the ROM 12, by which a network device recognition function, a monitoring target setting function, a judgment function, a packet acquisition function, a still image data generating function, an output control function and a storage control function are implemented. The printing device 2, being configured to have the function of the management device as above, acquires video data 34c via the network 5, generates still image data from the acquired video data 34c, and thereby prints out one or more still images as will be explained later.

FIG. 3 is a block diagram showing an example of the electrical configuration of each server 3. Each server 3 is configured as a personal computer (or work station) including a CPU 31, a RAM 32 having work memory, a ROM 33 storing various programs, an HDD 34 as a storage unit, a bus line 35, an input/output unit 36 (indicated as “I/O” in FIG. 3), a CD-ROM drive 39, a communication interface 40 (connected to the network 5 for transmitting and receiving video data 34c), etc. The HDD 34 and the CD-ROM drive 39 are connected to the bus line 35 via interfaces 44 and 49, respectively. The HDD 34 stores an OS 34a as the basic software of the server 3, a communication program 34b, video data 34c to be transmitted to the first-class network devices 4, etc. An input unit 37 (including a keyboard, a mouse, etc.) and a display unit 38 (implemented by an LCD or CRT) are connected to the input/output unit 36.

With the above configuration, the server 3 transmits video data 34c (as packets) via the network 5 when a video transmission request is received from a first-class network device 4.

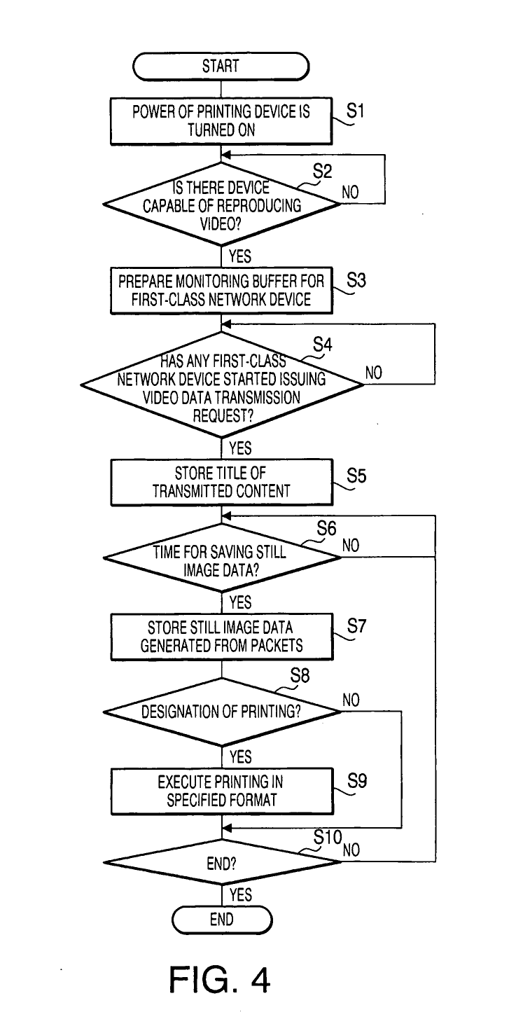

A video data monitoring process which is executed by the printing device 2 will be explained below referring to FIG. 4. When the power of the printing device 2 is turned ON (S1), the CPU 11 of the printing device 2 executes the communication program 12b and judges whether a first-class network device 4 capable of reproducing video from video data 34c exists on the network 5 or not by transmitting a search signal to devices on the network 5 according to the aforementioned UPnP, for example, and receiving response signals from the devices in response to the search signal (S2). The judgment on the presence/absence of a first-class network device 4 on the network 5 may either be made by detecting the first-class network device 4 itself or by discriminating between first-class network devices 4 and second-class network devices 7 by detecting the second-class network devices 7. When no first-class network device 4 exists on the network 5 (S2: NO), the CPU 11 thereafter makes the detection of a first-class network device 4 on the network 5 at preset time intervals.

When a first-class network device 4 on the network 5 is found (S2: YES), the CPU 11 of the printing device 2 prepares a monitoring buffer 13e in the RAM 13 for the detected first-class network device 4 (S3). By the recognition of a first-class network device 4 on (connected to) the network 5 by the printing device 2, the monitoring of video data 34c transmitted to the first-class network device 4 becomes possible. Subsequently, the CPU 11 of the printing device 2 monitors signals to check whether or not a first-class network device 4 has started issuing a transmission request to a server 3 (S4).

When a server 3 transmits video data 34c to a first-class network device 4, the server 3 broadcasts the video data 34c to all the devices connected to the network 5 while including destination data (specifying a first-class network device 4 as the destination of the video data 34) in the video data 34c. Therefore, the printing device 2 receives the video data 34c transmitted to the first-class network device 4 and stores the title of content contained in the received video data 34c in the monitoring buffer 13e of the RAM 13 (or in the storage unit 18) (S5).

The video data processing program 12c of the printing device 2 is configured to generate still image data based on the packets of the video data 34c at prescribed times of day and save the generated still image data. The CPU 11 of the printing device 2 constantly checks whether the time for saving the still image data has come or not. When the prescribed time has come (S6: YES), the CPU 11 identifies the destination of video data 34c based on the IP address contained in the transmitted packets of the video data 34c, generates the still image data from the packets of the video data 34c, and stores the generated still image data in the monitoring buffer 13e of the RAM 13 (or in the storage unit 18) (S7). In short, still image data contained in each piece of video data 34c is stored at prescribed times of day. In other words, multiple pieces of still image data based on packets are generated along a time series.

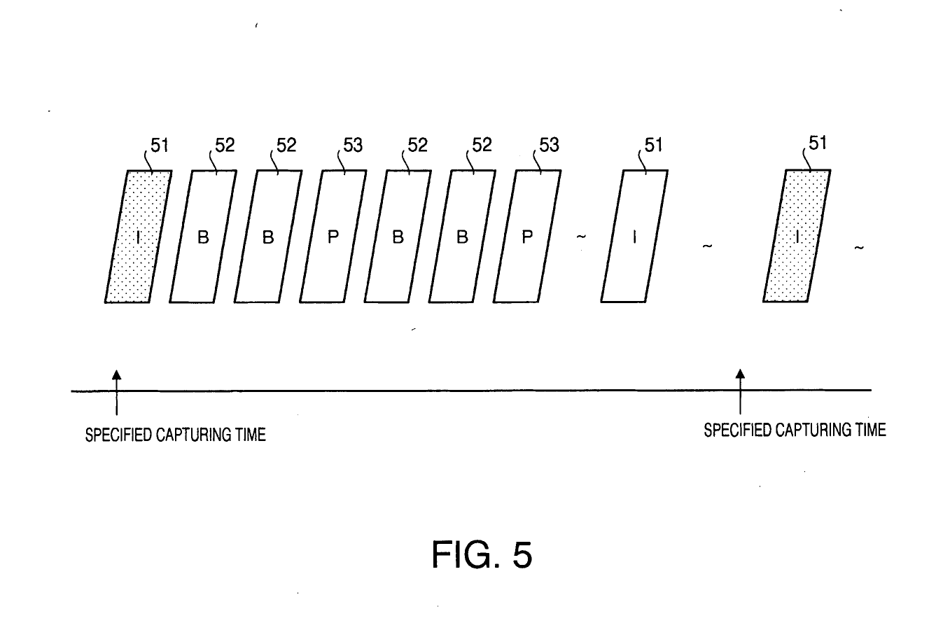

The storing of the still image data will be explained below referring to FIG. 5. The video data 34c stored in each server 3 to be transmitted to the first-class network devices 4a, 4b and 4c have been compressed and encoded according to MPEG, for example. The video data 34c compressed/encoded according to MPEG are made up of a plurality of frames arranged along a time series (I frame 51, B frame 52, B frame 52, P frame 53, B frame 52, B frame 52, P frame 53, . . . ).

The I frame 51, to be used as a reference frame, is a frame (image data) generated by compressing a whole image frame by intra-frame coding. The I frame 51 serves as a basis for the compression of other frames. Having been compressed according to a compressing concept similar to still image compression like JPEG, the I frame 51 includes information on a whole still image but does not include any information predicted from other frames. The P frame 53 is a frame (image data) obtained by inter-frame prediction coding by using the previous I frame 51 as the reference frame (reference image) and just saving the difference between the two frames without saving parts that are common to the two frames. The B frame 52 is a frame (image data) obtained by the inter-frame prediction coding by using the I frame 51 or the P frame 53 as the reference image.

The printing device 2 extracts and captures an I frame 51 (image data) that is immediately after a specified capturing time from all the video data 34c (compressed according to MPEG) contained in the packets transmitted from the server 3, and stores the captured I frame 51 (image data) as the still image data.

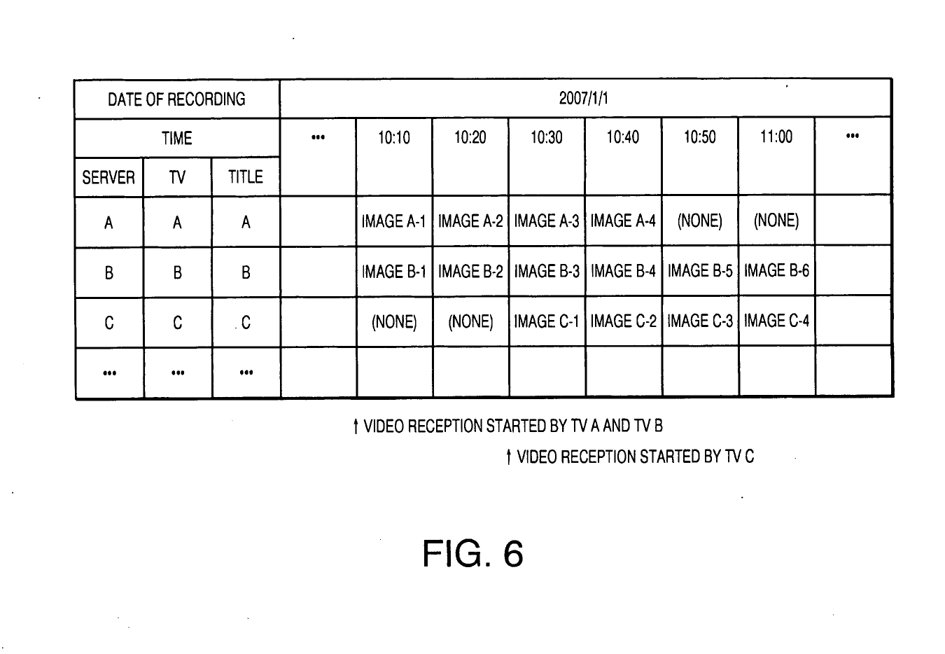

FIG. 6 is a table showing an example of a monitoring output screen which is displayed on the panel display unit 16, for example. In regard to each of the first-class network devices 4 (4a, 4b, 4c), the name of a server transmitting video data 34c to the first-class network device 4 (server name), the name of the first-class network device 4 receiving the video data 34c (TV name) and the title of the transmitted video data 34c (title) are outputted on the screen. Further, each image that was being transmitted at each prescribed time of day is outputted on the screen in regard to each of the first-class network devices 4 (4a, 4b, 4c). With the monitoring output screen, the user can learn what kind of video data 34c was transmitted to which first-class network device 4 (4a, 4b or 4c) and when each transmission was executed.

For example, with the monitoring output screen of FIG. 6, the user can learn that the first-class network device 4a (TV A) and the first-class network device 4b (TV B) had started the reception of video data 34c at 10:10 and the first-class network device 4c (TV C) had started the reception of video data 34c at 10:30. The user can further learn that the first-class network device 4a (TV A) had finished the reception of the video data 34c before 10:50.

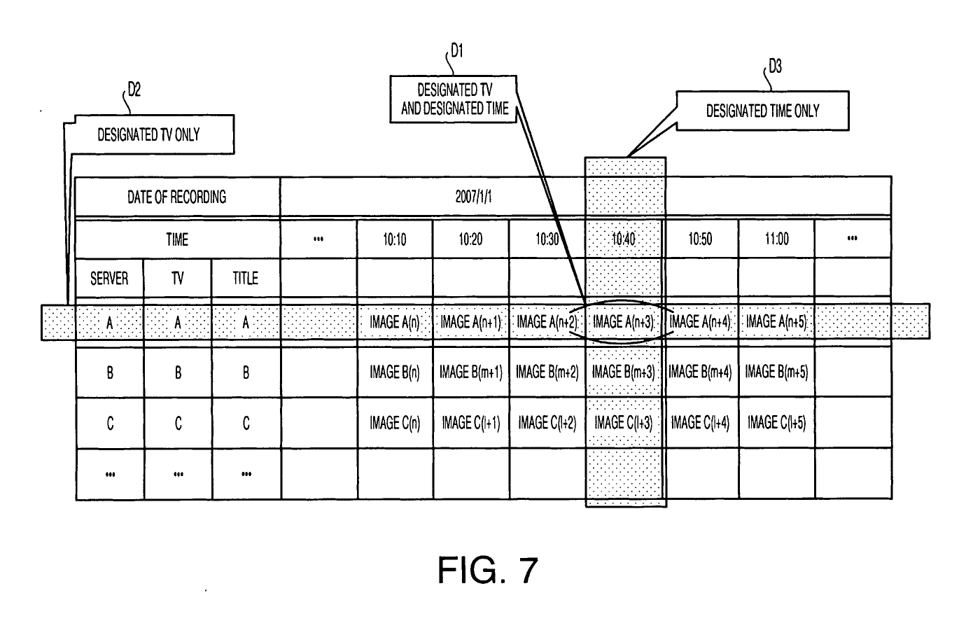

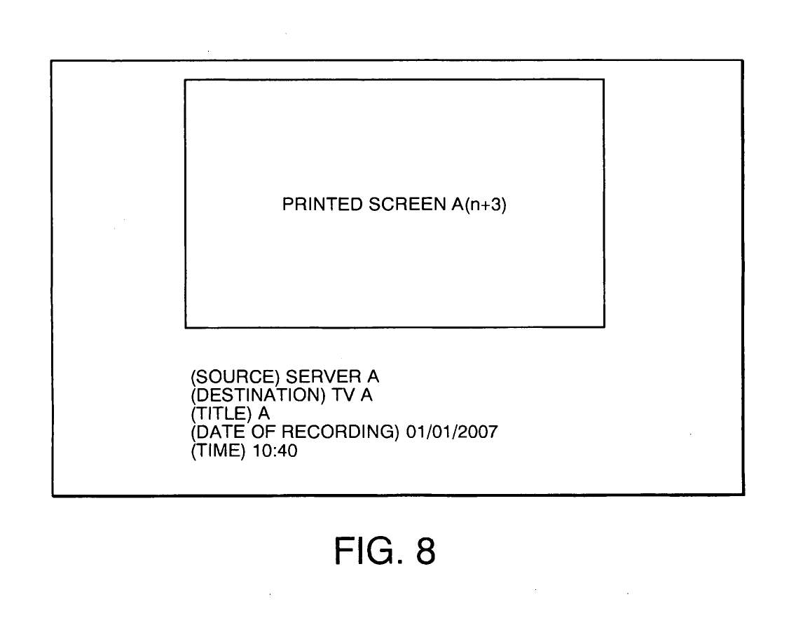

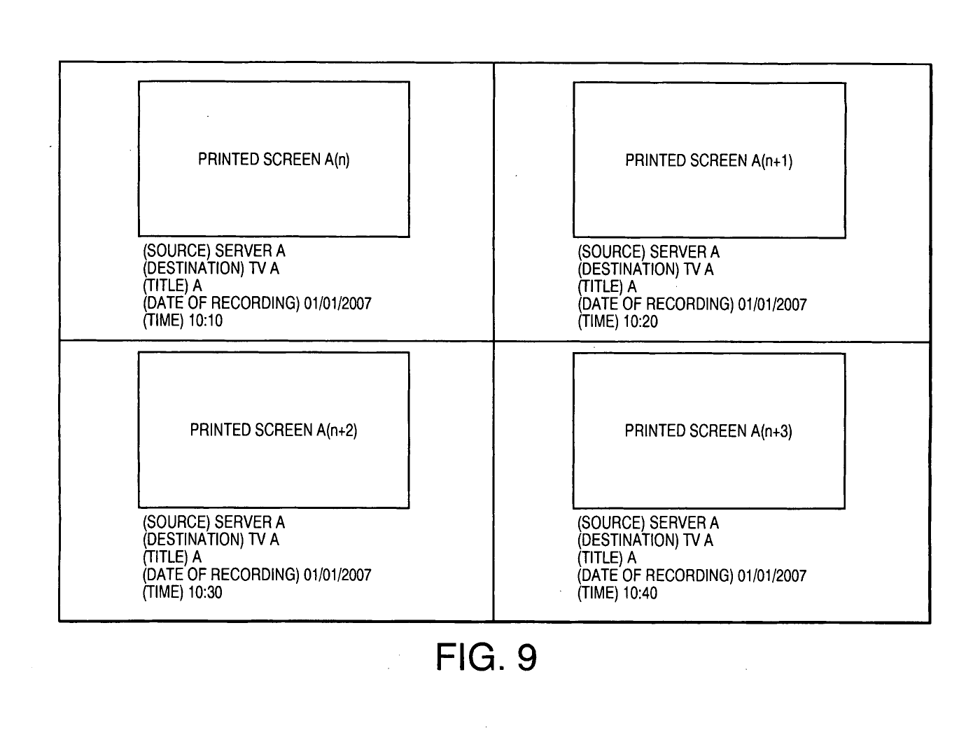

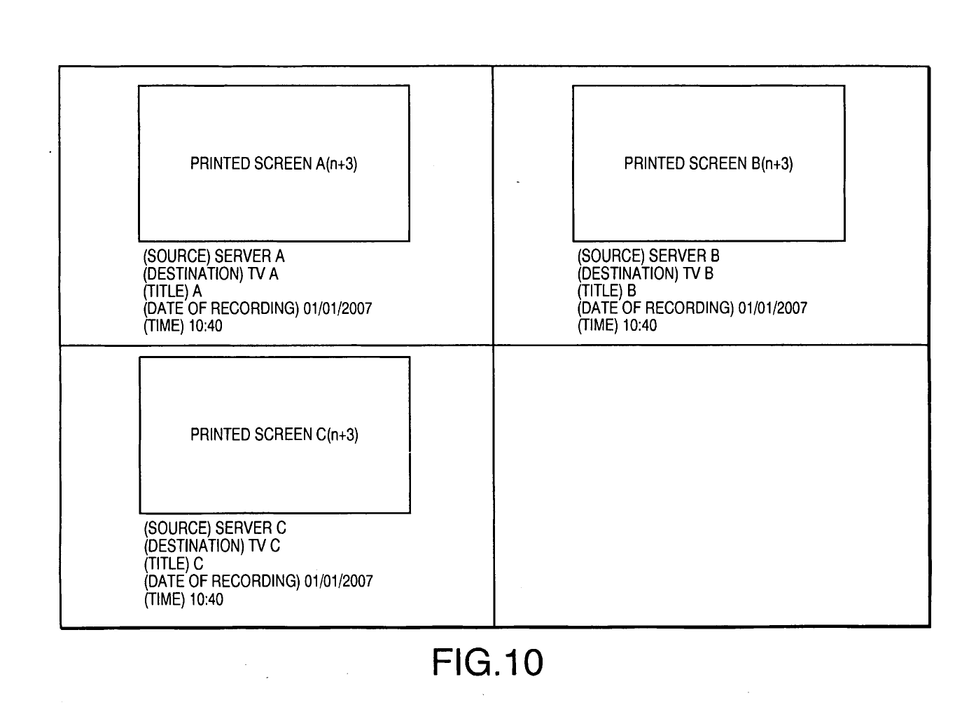

Returning to FIG. 4, when printing is designated by the user (S8: YES), the CPU 11 of the printing device 2 executes the printing in a specified format. Examples of the printout will be explained below referring to FIGS. 7-10. FIG. 7 is a schematic diagram showing the designation of a printout by a user operation, etc. When a TV and a time are designated as indicated with “D1” in FIG. 7, one screen is printed on a sheet (e.g. paper) by the printing device 2 as shown in FIG. 8. On the sheet, identification information such as the name of the source (server name), the name of the destination (first-class network device name) and the title is also printed out together with the still image (printed screen A(n+3)). When a TV is designated as indicated with “D2” in FIG. 7, video data 34c transmitted to the designated TV (TV A in FIG. 7) is printed out by the printing device 2 as a still image in regard to each prescribed time as shown in FIG. 9. When a particular time is designated as indicated with “D3” in FIG. 7, video data 34c transmitted to each TV at the designated time is printed out by the printing device 2 as a still image in regard to each TV as shown in FIG. 10.

Returning to FIG. 4, after the printing process, if the video data monitoring process is not to be ended (S10: NO), the CPU 11 of the printing device 2 returns to the step S6 and repeats the aforementioned steps.

### Second Embodiment

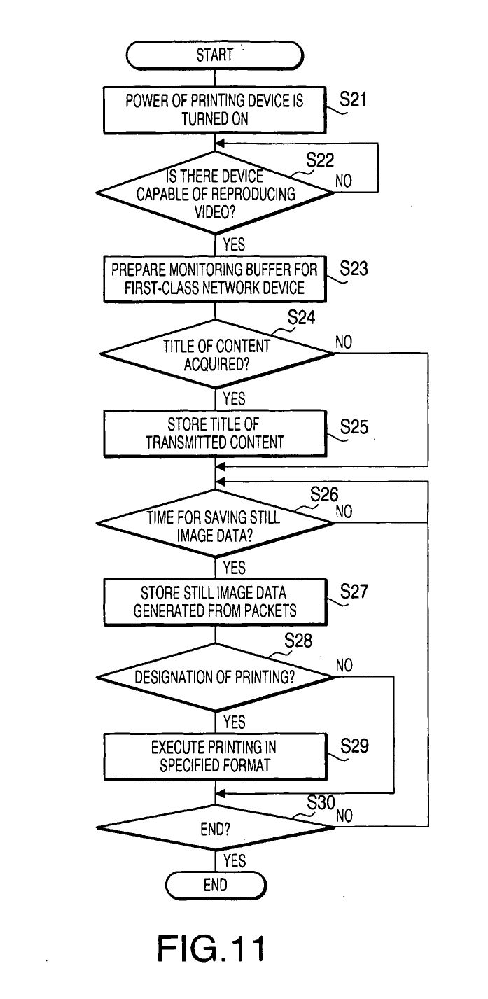

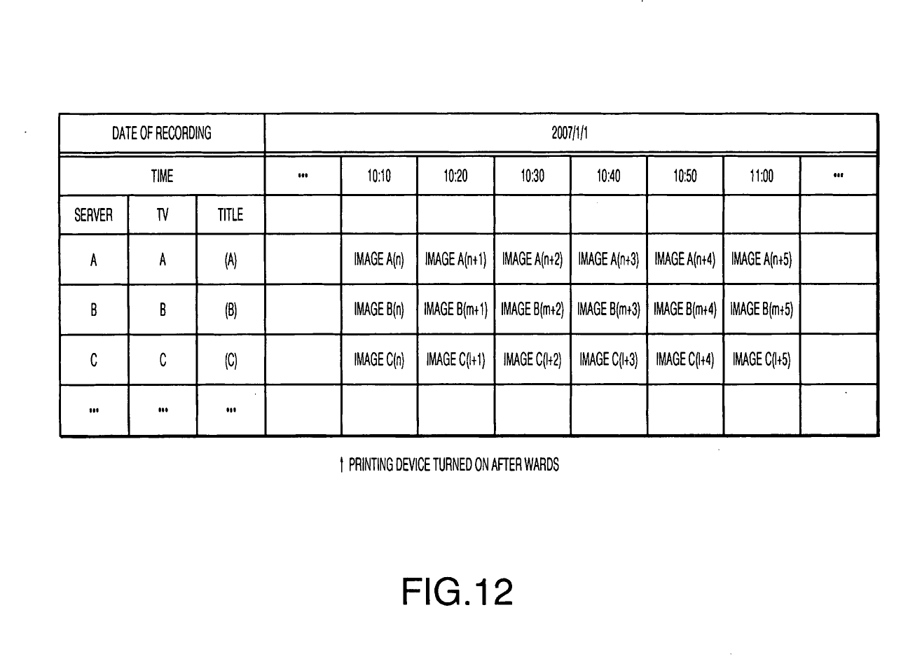

In the following, a process which is executed when the power of the printing device 2 as the management device is turned ON when the transmission of video data 34c to a first-class network device 4a, 4b or 4c has already been started will be explained referring to FIGS. 11 and 12. When the power of the printing device 2 is turned ON (S21), the CPU 11 of the printing device 2 judges whether a first-class network device 4 capable of reproducing video from video data 34c exists on the network 5 or not similarly to the above first embodiment (S22). When no first-class network device 4 exists on the network 5 (S22: NO), the CPU 11 thereafter makes the detection of a first-class network device 4 on the network 5 at preset time intervals.

When a first-class network device 4 is detected (S22: YES), the CPU 11 reserves a monitoring buffer 13e in the RAM 13 for the detected first-class network device 4 (S23). By the recognition of a first-class network device 4 connected to the network 5 by the printing device 2, the monitoring of video data 34c transmitted to the first-class network device 4 becomes possible.

In cases where video data 34c is being transmitted from a server 3 to a first-class network device 4, the printing device 2 receives the video data 34c transmitted to the first-class network device 4 and stores the title of content contained in the received video data 34c in the RAM 13 (or in the storage unit 18) (S25) if the title can be acquired (S24: YES). When the title of the content can not be acquired since the transmission of the video data 34c has already been started (S24: NO), the title is not stored in the RAM 13.

The video data processing program 12c of the printing device 2 is configured to generate still image data based on the packets of the video data 34c at prescribed times of day and save the generated still image data. The CPU 11 of the printing device 2 constantly checks whether the time for saving the still image data has come or not. When the prescribed time has come (S26: YES), the CPU 11 identifies the destination of video data 34c based on the IP address contained in the transmitted packets of the video data 34c, generates the still image data from the packets of the video data 34c, and stores the generated still image data in the monitoring buffer 13e of the RAM 13 (or in the storage unit 18) (S27). In short, still image data contained in each piece of video data 34c is stored at prescribed times of day. The printing device 2 extracts and captures an I frame 51 (image data) that is immediately after a specified capturing time from all the video data 34c (compressed according to MPEG) contained in the packets transmitted from the server 3, and stores the captured I frame 51 (image data) as the still image data. The still image data are stored as shown in FIG. 12, for example. In the example of FIG. 12, three pieces of video data 34c were being transmitted to the three first-class network devices 4a, 4b and 4c (TV A, TV B and TV C) at 10:10, respectively, and thus three pieces of still image data (image A(n), image B(n) and image C(n)) based on the three pieces of video data 34c have been stored in regard to the three first-class network devices 4a, 4b and 4c.

When printing is designated by the user (S28: YES), the CPU 11 of the printing device 2 executes the printing of one or more still images according to still image data in a specified format (S29). The printout can be obtained as shown in FIGS. 7-10, for example.

### Third Embodiment

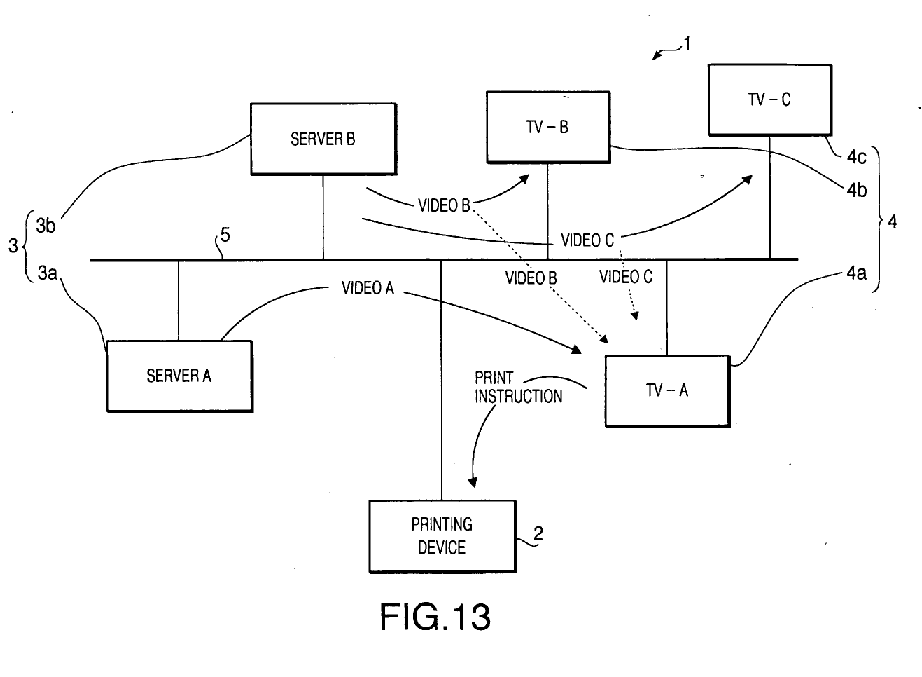

In the following, an embodiment in which the first-class network device 4a is configured as the management device will be explained referring to FIG. 13. The video data delivery system 1 shown in FIG. 13 includes servers 3 (which accumulate and deliver video data 34c), first-class network devices 4 (which reproduce video from the delivered video data 34c) and a printing device 2 which are connected together by a network 5. Among the three first-class network devices 4a, 4b and 4c, the first-class network device 4a is configured to function also as the management device. Meanwhile, the printing device 2 is just configured as a well-known network printer, for example.

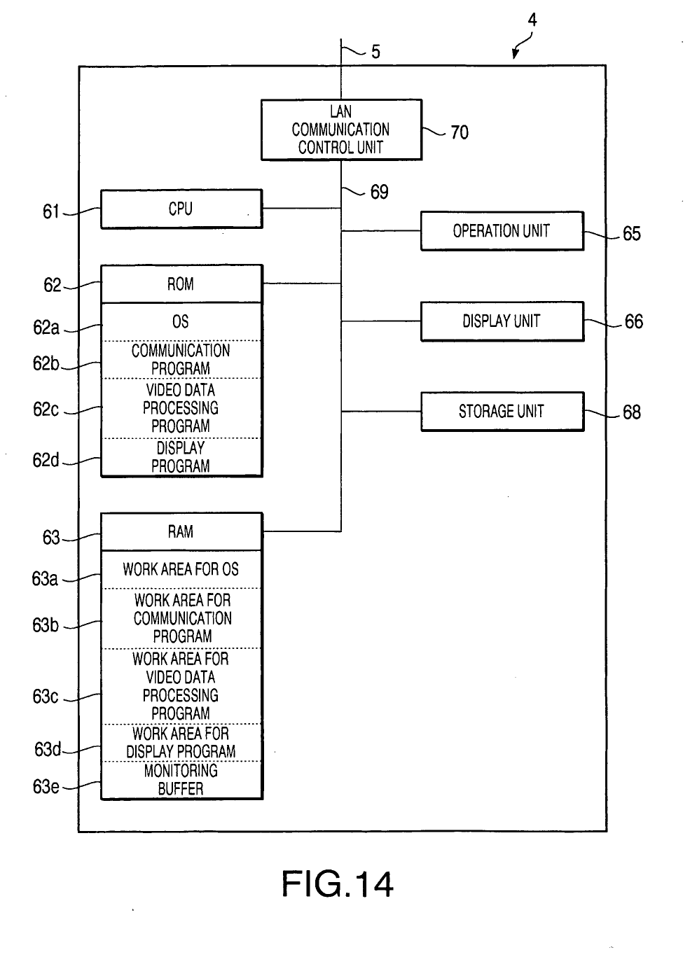

FIG. 14 is a block diagram showing an example of the composition of the first-class network device 4a configured as the management device in this embodiment. The first-class network device 4a includes a CPU 61, a ROM 62 storing various programs, a RAM 63 having work memory, an operation unit 65, a display unit 66, a storage unit 68, a bus line 69, and a LAN communication control unit 70 connected to the network 5. The first-class network device 4a is implemented by equipping the aforementioned network television with the function of the management device.

The CPU 61, as a central computation device for controlling the whole of the first-class network device 4a, is connected to the ROM 62 (explained later), the RAM 63 (explained later), etc. via the bus line 69. The CPU 61 reads out and executes the various programs stored in the ROM 62.

The ROM 62, as a read-only storage device, stores an OS 62a, a communication program 62b, a video data processing program 62c, a display program 62d for displaying video on the display unit 66 according to video data 34c, etc. Meanwhile, in the RAM 63, work areas 63a, 63b, 63c and 63d (for the programs 62a, 62b, 62c and 62d, respectively) and a monitoring buffer 63e are formed.

The operation unit 65 includes an input unit (made up of push button switches, etc.), etc. The display unit 66 is implemented by an LCD, etc. for example. Video according to video data 34c, etc. is displayed on the display unit 66 by the execution of the display program 62d by the CPU 61.

The storage unit 68, as a readable and writable storage device configured as an HDD, for example, stores data received from the network 5. The storage unit 68 may also be implemented by a nonvolatile memory like an EEPROM.

The video data 34c transmitted from the servers 3a and 3b and a list of the first-class network devices 4a, 4b and 4c (which have been found by a search and set as monitoring targets by the first-class network device 4a) are stored in the monitoring buffer 63e or the storage unit 68. In the list, intrinsic information on each of the first-class network devices 4a, 4b and 4c, such as a MAC address, an IP address and a device name, is stored.

The LAN communication control unit 70 is configured as a well-known LAN card, via which the first-class network device 4a is connected to the network 5.

With the above configuration, video (video data 34c) is transmitted from the servers 3 (server 3a (server A), server 3b (server B)) to the first-class network devices 4 (TV 4a (TV A), TV 4b (TV B), TV 4c (TV C)) as shown in FIG. 13, and the video data 34c are played back and displayed by the first-class network devices 4a, 4b and 4c. The first-class network device 4a is capable of receiving video data 34c from a server 3 and displaying video according to the received video data 34c. Being configured as the management device, the first-class network device 4a is also capable of detecting first-class network devices 4 connected to the network 5, generating still image data at each prescribed time based on video data 34c being transmitted to each of the first-class network devices 4, and storing the generated still image data. The first-class network device 4a is also capable of making the printing device 2 print out still images according to the still image data when a prescribed condition is satisfied. Detailed explanation of the printout is omitted for brevity since the printout can be obtained similarly to the above first and second embodiments. As above, the first-class network device 4a in this embodiment functions as the management device having the network device recognition function, the monitoring target setting function, the judgment function, the packet acquisition function, the still image data generating function and the output control function. The printing device 2 has an output function.

As described above, in the video data delivery systems 1 in accordance with the above embodiments of the present invention, the management device detects first-class network devices 4 (capable of reproducing video from video data 34c) connected to the network 5, acquires video data 34c transmitted to each of the first-class network devices 4, and saves parts of the acquired video data 34c as the still image data. With the configuration, the acquisition of the video data 34c transmitted via the network 5 can be achieved with ease. Further, by outputting still images according to the still image data, the management device can let the user know what kind of video data 34c is being delivered to each first-class network device 4, whether the video data 34c is being delivered normally or not, etc.

Incidentally, while a case where still image data is generated from packets of video data has been described in the above embodiments, the management device may also be configured to generate “monitoring video data” (having a reduced number of image frames per unit time compared to the video data transmitted to the first-class network devices) based on the packets of the video data. Also with such a configuration displaying part of the video data as video (monitoring video data), the amount of outputted data can be reduced and the monitoring of the video data can be executed efficiently. In this case, the CPU 11 of the printing device 2 (see FIG. 2) having the function of the management device or the CPU 61 of the first-class network device 4a (see FIG. 14) having the function of the management device executes the monitoring video data generating function.

While a description has been given above of preferred embodiments in accordance with the present invention, the present invention is not to be restricted by the particular illustrative embodiments and a variety of modifications, design changes, etc. are possible without departing from the scope and spirit of the present invention described in the appended claims. Various types of output devices such as an image recording device having the above mentioned video data monitoring function may be used in place of the printer 2.

What is claimed is:

1. A management device for monitoring video data transmitted via a network, comprising:
a network device recognition unit configured to identify at least one predetermined device in the network by judging whether the at least one predetermined device satisfies a predetermined condition;
a monitoring target setting unit which sets the at least one predetermined device identified by the network device recognition unit as a monitoring target;
a judgment unit which judges whether or not video data is being transmitted via the network to the at least one predetermined device set by the monitoring target setting unit as the monitoring target;
a packet acquisition unit which acquires packets of the video data being transmitted to the at least one predetermined device on the network if the judgment unit judges that the video data is being transmitted to the at least one predetermined device;
a monitoring image data generating unit which generates monitoring image data based on the packets of the video data acquired by the packet acquisition unit; and
an output control unit which makes an output unit output the monitoring image data generated by the monitoring image data generating unit.

2. The management device according to claim 1, wherein the predetermined condition used by the network device recognition unit is a condition on whether the predetermined device is able to reproduce video data.

3. The management device according to claim 1, wherein:
the network device recognition unit recognizes and discriminates between first-class network devices receiving video data via the network and having a video reproducing function of reproducing video according to the received video data and second-class network devices not having the video reproducing function on the network on which the first-class network devices and the second-class network devices coexist so that the first-class network devices are identified as the at least one predetermined device;
the monitoring target setting unit sets the first-class network devices recognized by the network device recognition unit as monitoring targets;
the judgment unit judges whether or not video data is being transmitted via the network to each of the first-class network devices set by the monitoring target setting unit as the monitoring targets; and
the packet acquisition unit which acquires packets of the video data being transmitted to each first-class network device on the network if the judgment unit judges that the video data is being transmitted to the first-class network device.

4. The management device according to claim 1, wherein:
the monitoring image data generating unit generates monitoring video data, having a reduced number of image frames per unit time compared to the video data transmitted to the at least one predetermined device, as the monitoring image data based on the packets of the video data acquired by the packet acquisition unit, and
the output control unit makes the output unit output video according to the monitoring video data as the monitoring images.

5. The management device according to claim 1, wherein:
the monitoring image data generating unit is a still image data generating unit which generates still image data as the monitoring image data, and
the output control unit makes the output unit output one or more still images according to the still image data as the monitoring images.

6. The management device according to claim 5, wherein:
the packet acquisition unit continues periodical acquisition of the packets of the video data while the video data is transmitted to the at least one predetermined device;
the still image data generating unit generates still image data of a plurality of still images along a time series of packet acquisition by the packet acquisition unit based on the packets of the video data acquired by the packet acquisition unit, and
the output control unit makes the output unit output the still images according to the still image data.

7. The management device according to claim 5, further comprising a storage control unit which stores the still image data in a storage unit, wherein:
the output control unit makes the output unit output one or more still images according to the still image data stored in the storage unit in response to receipt of an output request from a user.

8. The management device according to claim 5, wherein the output control unit makes the output unit print out one or more still images according to the still image data.

9. The management device according to claim 3, wherein the output control unit makes the output unit output identification information, capable of specifying the first-class network device reproducing video according to the video data formed by the packets, together with the monitoring images.

10. The management device according to claim 1, wherein the output control unit makes the output unit output identification information, capable of specifying a server as the source of the packets, together with the monitoring images.

11. The management device according to claim 1, wherein the output control unit makes the output unit output identification information, capable of specifying the video data formed by the packets, together with the monitoring images.

12. The management device according to claim 1, wherein the judgment unit makes the judgment on whether or not video data is being transmitted to the at least one predetermined device by judging whether or not the at least one predetermined device has issued a video data transmission request to a server on the network.

13. A computer readable medium having computer readable instructions stored thereon, which, when executed by a computer, are configured to:
identify at least one predetermined device in the network by judging whether the at least one predetermined device satisfies a predetermined condition;
set the at least one predetermined device as a monitoring target;
judge whether or not video data is being transmitted via the network to the at least one predetermined device set as the monitoring target;
acquire packets of the video data being transmitted to the at least one predetermined device on the network if it is judged that the video data is being transmitted to the at least one predetermined device;
generate monitoring image data based on the acquired packets of the video data; and
make an output unit output the monitoring image data generated as monitoring images.

14. The computer readable medium according to claim 13, wherein the predetermined condition is a condition on whether the at least one predetermined device has a video reproducing function.

15. A method of monitoring video data transmitted via a network, comprising:
identifying at least one predetermined device in the network by judging whether the at least one predetermined device satisfies a predetermined condition;
setting the at least one predetermined device as a monitoring target;
judging whether or not video data is being transmitted via the network to the at least one predetermined device set as the monitoring target;
acquiring packets of the video data being transmitted to the at least one predetermined device on the network if it is judged that the video data is being transmitted to the at least one predetermined device;
generating monitoring image data based on the acquired packets of the video data; and
making an output unit output the monitoring image data generated as monitoring images.

16. The method according to claim 15, wherein the predetermined condition is a condition on whether the at least one predetermined device has a video reproducing function.
